(19) United States
(12) Patent Application Publication
(10) Pub. No.: US 2026/0084501 A1
(43) Pub. Date: Mar. 26, 2026

(54) VEHICLE BODY STRUCTURE

(71) Applicant: TOYOTA JIDOSHA KABUSHIKI KAISHA, Aichi-ken (JP)

(72) Inventor: Tatsuya SHIMIZU, Okazaki-shi (JP)

(21) Appl. No.: 19/319,728

(22) Filed: Sep. 5, 2025

(30) Foreign Application Priority Data
Sep. 25, 2024 (JP) 2024-166178

(51) Int. Cl. B60J 5/10; B62D 29/04

(52) U.S. Cl. CPC B60J 5/10; B62D 29/043

(57) ABSTRACT

A vehicle body structure includes a body having an opening in a design surface; and a back door that opens and closes the opening. The body includes a frame portion recessed from the design surface at a peripheral edge of the opening. An outer peripheral portion of the back door engages with the frame portion and an end portion of the outer peripheral portion has lower strength than other portions of an opening and closing body.

### CROSS REFERENCE TO RELATED APPLICATION

This application claims priority to Japanese Patent Application No. 2024-166178 filed on Sep. 25, 2024, which is incorporated herein by reference in its entirety including the specification, claims, drawings, and abstract.

### TECHNICAL FIELD

The present disclosure relates to a structure of a vehicle body.

### BACKGROUND

JPH5-116533A discloses a back door driving device that forms a space between a rear end of a back door and a body into which a finger can be inserted when the back door is closed.

### SUMMARY

When a foreign matter is caught between a door and an opening/closing body such as a body, it is required to provide a survival space for the foreign matter in order to prevent the foreign matter from being damaged. However, when an additional component is attached as described in JPH5-116533A in order to provide a survival space, the structure becomes complicated, and the design of the body may need to be limited.

Accordingly, an object of the present disclosure is to secure a survival space for foreign matter between an opening/closing body and a body with a simple structure.

A vehicle body structure according to an embodiment of the present disclosure includes a body having an opening in a design surface and an opening and closing body for opening and closing the opening. The body includes a frame portion recessed from the design surface at peripheral portion of the opening. An outer peripheral portion of the opening and closing body fits the frame portion and an end portion of the outer peripheral portion has a lower strength than other portions of the opening and closing body.

Accordingly, in the vehicle body structure of the present disclosure, when a foreign matter is caught between the end portion of the opening/closing body and the frame portion of the body, the end portion can be deformed. Therefore, the vehicle body structure of the present disclosure can secure the survival space of the foreign matter with a simple configuration.

In the vehicle body structure of the present disclosure, an outer plate of the opening and closing body may be made of resin.

Thus, the end portion of the opening and closing body can be easily deformed.

In the vehicle body structure of the present disclosure, the thickness of the end portion of the outer plate may be thinner than the thickness of other portions of the outer plate.

Accordingly, the strength of the end portion can be reduced with a simple configuration so that the end portion can be easily deformed. As a result, when the foreign matter is caught between the end portion of the opening/closing body and the frame portion of the body, the end portion is deformed and a survival space of the foreign matter can be secured.

In the vehicle body structure of the present disclosure, the end portion of the outer plate may comprise a notch.

As a result, since the end portion is deformed from the notch as a starting point, when the foreign matter is caught between the end portion of the opening/closing body and the frame portion of the body, the end portion is reliably deformed, and the survival space of the foreign matter can be secured.

According to the present disclosure, it is possible to secure a survival space for foreign matter between an opening/closing body and a body with a simple structure.

### BRIEF DESCRIPTION OF DRAWINGS

FIG. 1 is an elevational view of a vehicle provided with a vehicle body structure according to an embodiment of the present disclosure as viewed from the rear;

FIG. 2 is a cross-sectional view of the vehicle body structure according to the embodiment, and is a cross-sectional view taken along line A-A of FIG. 1;

FIG. 3 is a cross-sectional view of a vehicle body structure according to another embodiment.

### DESCRIPTION OF EMBODIMENTS

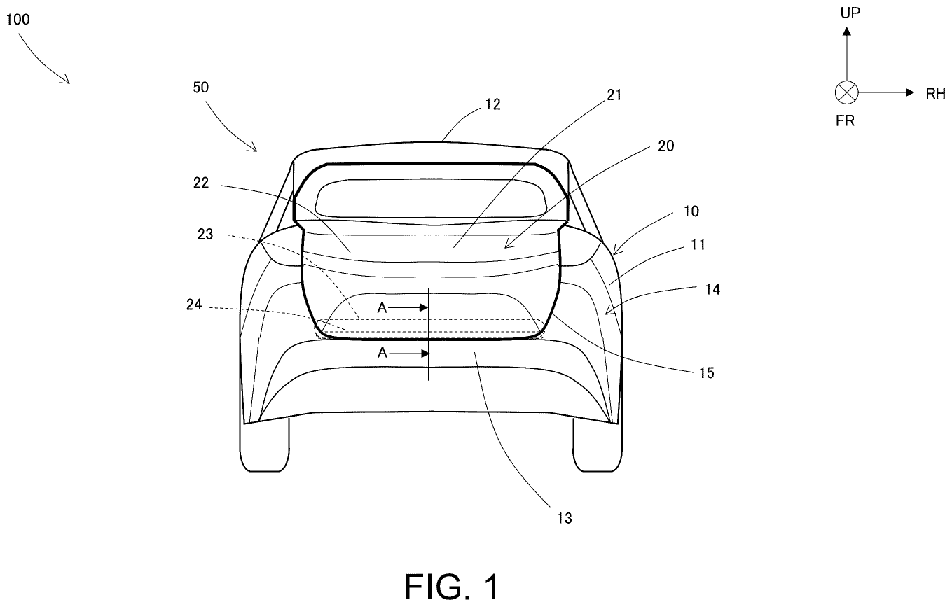

Hereinafter, a vehicle body structure 50 according to an embodiment will be described with reference to the drawings. First, a vehicle 100 including a vehicle body structure 50 will be described with reference to FIG. 1. Note that FR, UP, and RH shown in the drawings indicate a front side, an upper side, and a right side of the vehicle 100 including the vehicle body structure 50, respectively. The opposite directions of FR, UP, and RH indicate the rear side, the lower side, and the left side, respectively. Hereinafter, in the case where the front-rear direction, the left-right direction, and the up-down direction are simply used, the front-rear direction, the left-right direction, and the up-down direction of the vehicle 100 are indicated unless otherwise specified.

As shown in FIG. 1, the rear portion of the body 10 of the vehicle 100 includes left and right rear side panels 11, a roof panel 12, and a bumper 13. The left and right rear side panels 11 form side surfaces of the rear portion of the body 10. The roof panel 12 connects upper ends of the left and right rear side panels 11 in the vehicle width direction and forms an upper surface of a rear portion of the body 10. The bumper 13 connects lower portions of the left and right rear side panels 11 in the vehicle width direction. The outer surfaces of the left and right rear side panels 11, the outer surface of the roof panel 12, and the outer surface of the bumper 13 constitute a design surface 14 of the rear portion of the body 10.

The design surface 14 is provided with an opening 15 defining upper, lower, left, and right sides by the rear end of the roof panel 12, the upper end of the bumper 13, and the vehicle width direction center ends of the left and right rear side panels 11.

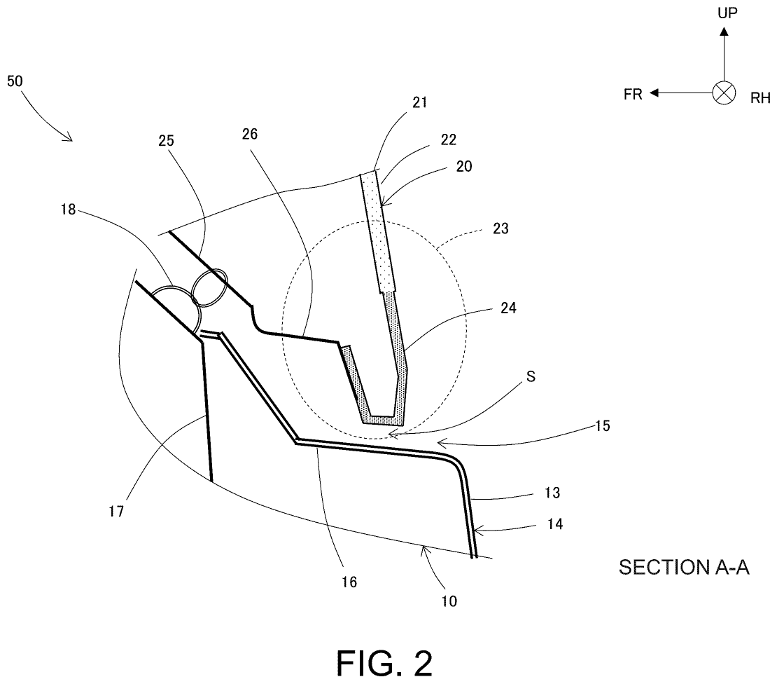

As shown in FIG. 2, the peripheral edge of the opening 15 is provided with a frame portion 16 recessed from the design surface 14. A metal rear inner panel 17 is provided inside the frame portion 16. The frame portion 16 is connected to the rear inner panel 17. The rear inner panel 17 is provided with a seal rubber 18. An inner opening (not shown) communicating with the inside of the rear compartment (not shown) is provided inside the seal rubber 18.

Returning to FIG. 1, a back door 20 for opening and closing the opening 15 is attached to the body 10. The back door 20 is rotatably attached to the roof panel 12 by a hinge provided at an upper end thereof. The back door 20 is an opening and closing body that opens and closes the opening 15 by rotating around a hinge.

As shown in FIG. 2, the back door 20 includes an outer panel 21 made of resin and an inner panel 25 made of metal.

A hinge is attached to the inner panel 25, and the inner panel 25 is rotatably connected to the roof panel 12. The outer edge portion 26 at the lower end of the inner panel 25 extends into the outer peripheral portion 23 of the back door 20. The outer edge portion 26 is provided with a lock mechanism (not shown) for fixing the back door 20 to the body 10. When the back door 20 is closed, a hook (not shown) of the lock mechanism engages with a striker (not shown) fixed to the frame portion 16. Thus, the outer peripheral portion 23 of the back door 20 engages with the frame portion 16 and is supported by the frame portion 16.

The outer panel 21 is an outer plate whose outer surface constitutes a design surface. The outer panel 21 includes a main body portion 22 and an end portion 24 extending from the main body portion 22 into the outer peripheral portion 23. A light shaded portion in FIG. 2 indicates the main body portion 22, and a dark shaded portion in FIG. 2 indicates the end portion 24. The end portion 24 is connected to a lower portion of the main body portion 22 and folded back in the outer peripheral portion 23. The folded portion is connected to the outer edge portion 26 of the inner panel 25. Thus, the end portion 24 is an end portion of the outer peripheral portion 23 that engages the frame portion 16. The plate thickness of the end portion 24 is thinner than that of the main body portion 22, which is a portion other than the end portion 24. Therefore, the strength of the end portion 24 is lower than that of the main body portion 22.

Although the vertical length of the end portion 24 can be freely selected, it may be, for example, about 1 to 5 cm.

In the vehicle body structure 50 configured as described above, when a foreign matter is caught in the gap S between the end portion 24 of the back door 20 and the frame portion 16 of the body 10, the end portion 24 made of a resin having a small plate thickness and a low strength is deformed, so that a survival space for the foreign matter can be secured.

As described above, the vehicle body structure 50 of the embodiment can secure a survival space for foreign matter between the back door 20 and the frame portion 16 of the body 10 with a simple structure.

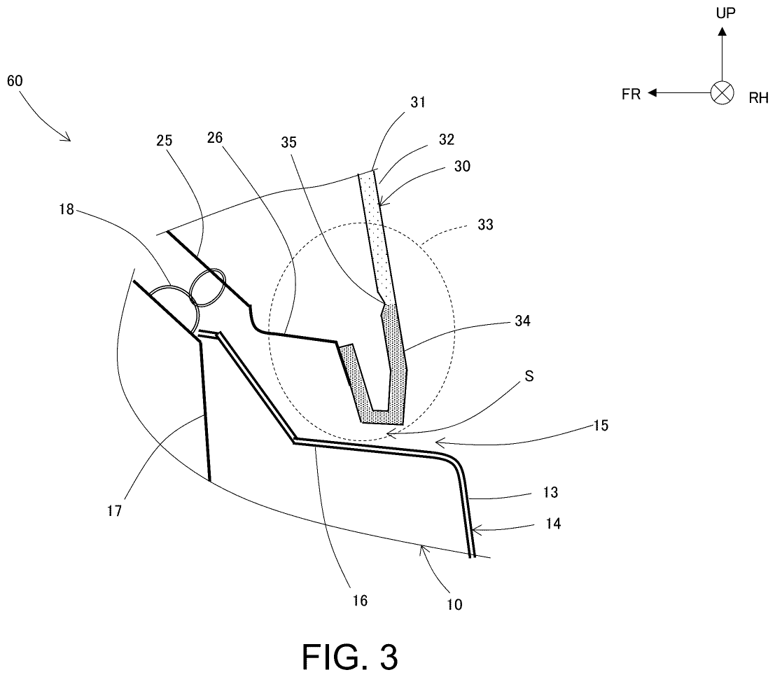

Next, a vehicle body structure 60 according to another embodiment will be described with reference to FIG. 3. The same parts as those of the vehicle body structure 50 described above with reference to FIGS. 1 and 2 are denoted by the same reference numerals, and description thereof is omitted.

The vehicle body structure 60 includes a back door 30. The back door 30 includes an outer panel 31 and an inner panel 25.

The outer panel 31 includes a main body portion 32 and an end portion 34. The end portion 34 is connected to a lower portion of the main body portion 32 and folded back in the outer peripheral portion 33. The folded portion is connected to the outer edge portion 26 of the inner panel 25. A light shaded portion in FIG. 3 indicates the main body portion 32, and a dark shaded portion in FIG. 3 indicates the end portion 34. The plate thickness of the end portion 34 is the same as the plate thickness of the main body portion 22. A notch 35 is provided at a boundary between the main body portion 32 and the end portion 34 of the outer panel 31. The notch 35 is a V-shaped groove extending in the vehicle width direction. Therefore, the strength of the end portion 34 is lower than that of the main body portion 32.

In the vehicle body structure 60 configured as described above, when a foreign matter is caught in the gap S between the end portion 34 of the back door 30 and the frame portion 16 of the body 10, the resin end portion 34 is bent and deformed with the notch 35 as a starting point. Thus, a survival space for foreign matter can be secured between the back door 30 and the frame portion 16 of the body 10.

In the above description, the notch 35 is provided at the boundary between the main body portion 32 and the end portion 34, but is not limited thereto, and may be provided in the end portion 34.

In the above description, the vehicle body structures 50 and 60 including the back doors 20 and 30 as the opening and closing bodies have been described, but the opening and closing bodies are not limited to the back doors 20 and 30. For example, in the vehicle body structure 50, the opening and closing body may be a front door and a rear door of the vehicle 100. In the vehicle body structure 50, the opening and closing body may be a hood in front of the vehicle 100.

1. A vehicle body structure comprising:
a body having an opening in a design surface; and,
an opening and closing body for opening and closing the opening, wherein
the body includes a frame portion recessed from the design surface at peripheral portion of the opening,
an outer peripheral portion of the opening and closing body fits the frame portion, and
an end portion of the outer peripheral portion has a lower strength than other portions of the opening and closing body.

2. The vehicle body structure according to claim 1, wherein an outer plate of the opening and closing body is made of resin.

3. The vehicle body structure according to claim 2, wherein
the thickness of the end portion of the outer plate is thinner than the thickness of other portions of the outer plate.

4. The vehicle body structure according to claim 2, wherein
the end portion of the outer plate comprises a notch.
